(19) United States
(12) Patent Application Publication
(10) Pub. No.: US 2023/0309189 A1
(43) Pub. Date: Sep. 28, 2023

(54) 5G MULTICAST/BROADCAST MULTIMEDIA SUBSYSTEM (5MBS) INDIVIDUAL DELIVERY

(71) Applicant: Telefonaktiebolaget LM Ericsson (publ), Stockholm (SE)

(72) Inventors: Hans Bertil RÖNNEKE, Kungsbacka (SE); Jie LING, Shanghai (CN); Juying GAN, Shanghai (CN)

(21) Appl. No.: 18/040,464

(22) PCT Filed: Aug. 3, 2021
(86) PCT No.: PCT/IB2021/057117

§ 371 Date: Feb. 3, 2023

(30) Foreign Application Priority Data
Aug. 7, 2020 (WO) PCT/CN2020/107698

(51) Int. Cl. H04W 76/40; H04W 8/22

(52) U.S. Cl. CPC H04W 76/40; H04W 8/22

(57) ABSTRACT

Apparatuses and methods for 5G Multicast Broadcast Services (5MBS) individual delivery are disclosed. In one embodiment, a core network node is configured to determine a radio access network, RAN, capability indication; and as a result of a request from a user equipment, UE, to join a multicast/broadcast, MB, session, sending a MB session response based on the RAN capability indication and at least one of a disable individual delivery parameter related to a multicast broadcast service, MBS, and a policy. In one embodiment, an application function, AF, node is configured to determine whether to disable an individual multicast broadcast service, MBS, traffic delivery for a multicast/broadcast, MB, session to at least one user equipment, UE; and send to a network node a disable individual delivery parameter associated with the MB session based at least in part on the determination.

### TECHNICAL FIELD

The present disclosure relates to wireless communication and in particular, methods and apparatuses for 5G Multicast Broadcast Services (5MBS) individual delivery.

### BACKGROUND

Third Generation Partnership Project (3GPP) has developed the MBMS (Multicast/Broadcast Multimedia Subsystem, see 3GPP Technical Specification (TS) 23.246 version 16.1.0) for 3^{rd} Generation (3G) networks for video multicast/broadcasting and streaming services and later introduced the eMBMS (evolved MBMS) for Evolved Packet System (EPS). In 3GPP Release 13 (Rel-13) and 3GPP Release 14 (Rel-14), the MBMS system was updated to support new services such as Public Safety, Carrier Aggregation Internet of Things (CIoT) and vehicle-to-everything (V2X).

The scope of a new 3GPP Release-17 study in the 3GPP Service and System

Aspects Working Group 2 (SA2) is to study both multicast requirements and use cases for Public Safety, Cellular-IoT, V2X, etc., and dedicated broadcasting requirements and use cases. The study targets the Third Generation Partnership Project (3GPP) 5^{th} Generation (5G, also called New Radio) Release 17 and the New Radio (NR) radio access. The study results so far has been documented in the 3GPP Technical Report (TR) 23.757 Version (V) 0.4.0.

Multicast/Broadcast services (MBS) are so far not supported in 5G NR. With the enhanced characteristics of the 5G NR, e.g., short delays, bandwidth, etc., it is believed Mission Critical Services i.e., Mission Critical Push To Talk (MCPTT), Mission Critical Data (MCData) and Mission Critical Video (MCVideo), as well as V2X services, will show an enhanced and much better performance in 5G NR.

In TR 23.757 V 0.4.0. Chapter 4.4 “MBS Traffic Delivery Methods”, two delivery methods from 5G Core (5GC) have been considered:
5GC Individual MBS traffic delivery method: 5G Core Network (CN) receives a single copy of MBS data packets and delivers separate copies of those MBS data packets to individual user equipments (UEs) via per-UE protocol data units (PDU) sessions. NOTE: It will be determined based on the selected solutions whether the Individual delivery method is supported.
5GC Shared MBS traffic delivery method: 5G CN receives a single copy of MBS data packets and delivers a single copy of those MBS packets packet to a radio access node (RAN) node, which then delivers them to one or multiple UEs.

If 5GC Individual MBS traffic delivery method is supported, a same received single copy of MBS data packets by the 5G CN may be delivered via both 5GC Individual MBS traffic delivery method for some UE(s) and 5GC Shared MBS traffic delivery method for other UEs.

FIG. 1 is a diagram showing example delivery methods. FIG. 1 shows a RAN 10 (e.g., 5G RAN), multiple UEs 12a, 12b, 12c and 12d (collectively UEs 12) and a core network 14 (e.g., 5G CN). The “5GC Shared MBS traffic delivery method” may be applied for UEs 12 within the NG-RAN 10 with 5G Multicast/Broadcast Multimedia Subsystem (5MBS) support, while the “5GC Individual MBS traffic delivery method” could be utilized for UEs 12 within NG-RAN 10 without 5MBS support, as well as when UEs 12 receiving an 5MBS session move to Evolved Universal Terrestrial Radio Access Network (E-UTRAN).

Two architecture options are proposed in TR 23.757 v0.4.0: architecture option #1 in Annex A.1 and architecture option #2 in Annex A.2. Related to the different architecture options, option #1 and architecture option #2, there was proposed different solutions, Solution #2 and Solution #3:

Solution #2 in chapter 6.2 of TR 23.757 v0.4.0 is the main solution for 5MBS Multicast support based on architecture option #2 (see TR 23.757 v0.4.0 Annex A.2). Within this Solution #2, the “5GC Shared MBS traffic delivery method” has been defined, while the “5GC Individual MBS traffic delivery method” (below also called “5MBS Individual Delivery”) has not been introduced.

FIG. 2 illustrates an example call flow diagram for Session Start in solution 2. FIG. 2 includes UE 12, NG-RAN 10, Access and Mobility Management Function (AMF) 16, Multicast/Broadcast Session Management Function (MB-SMF) 18, Multicast/Broadcast User Plane Function (MB-UPF) 20, policy and charging function (PCF) 22, network exposure function (NEF/MBSF) 24 and application function (AF) 26. Within this solution, Solution #2, after session start, the media stream will always be delivered from AF 26 to MB-UPF 20 to NG-RAN 10 in step 16 in Shared delivery mode.

As can be seen in FIG. 2, Solution #2 of TR 23.757 v0.4.0 includes:
0. Registration, group control and session join;
1. Activate MBS Bearer Req (TMGI, HL MC address, Service Requirement);
2. MB Session Start (TMGI, Service Requirement);
3. MB Session Start (TMGI, Service Requirement);
3. MB Session Start Resp (TMGI, 5G QoS Profile);
4. MB Session Resource Setup Request (LL MC address);
4. MB Session Resource Setup Response (N6 Tunnel Info);
5. MB Session Start (TMGI, LL MC, 5G Authorized QoS Profile);
6. Group Paging Req (TMGI);
6. Group Paging;
7. UL NAS: MB Session Join Request (TMGI);
8. DL NAS: MB Session Join Accept;
9. along N2: MB Session Join (NGAP ID, TMGI);
10. MB Session Resource Setup Request (TMGI, LL MC address, 5G Authorized QoS Profile);
10. MB Session Ctx created (active);
11. PTM/PTP establishment;
11. MLD/IGMP Join (LL MC address);
12. MB Session Resource Setup Response;
13. MB Session Start Ack;
14. MB Session Start Ack (N6 Tunnel Info);
15. Activate MBS Bearer Resp (N6 Tunnel Info);
16. Media stream; and
17. PTM/PTP transmission.

Solution #3 in chapter 6.3 of TR 23.757 v0.4.0 is the main solution for 5MBS Multicast support based on architecture option #1 (see TR 23.757 Annex A.1). Within this solution, both “5GC Shared MBS traffic delivery method” and “5GC Individual MBS traffic delivery method” have been defined. FIG. 3 illustrates a PDU Session modification for multicast in solution #3. FIG. 3 includes UE 12, RAN 10, AMF 16, SMF1 18a, UPF1 20a, Unified Data Repository (UDR) 28, SMF2 18b, UPF2 20b and a content provider 30.

As can be seen in FIG. 3, Solution #3 of TR 23.757 v0.4.0 includes:
11b. Multicast Distribution Request;
12b. Multicast Distribution Request;
13b. N4 Session Modification;
14b. Multicast Distribution Response;
15b. Multicast Distribution Response;
16b. N2 Session Response;
17b. Nsmf_PDUSession_Update SMContext;
18. Multicast Data;
19. Multicast Data;
20. Bearer Selection;
21. Multicast Data via unicast or multicast bearer;
22. Multicast Distribution Request;
23. N4 Session Modification;
24. Multicast Distribution Response;
25. N4 Session Modification;
26. Namf Communication_N1N2Message Transfer;
27. N2 Session Request;
28. PDU session Modification;
29. N2 Session Response;
30. Nsmf_PDUSession_Update SMContext;
31. Multicast Data;
32. Multicast Data;
33. Multicast Data via unicast PDU session; and
34. Multicast Data via unicast PDU session.

Within Solution #3, the “multicast distribution” is the implementation of “5GC Shared MBS traffic delivery method”, while the “unicast distribution via PDU session” is the implementation of the “5GC Individual MBS traffic delivery method”.

Solution #2 has drawbacks since it does not support “5GC Individual MBS traffic delivery”.

### SUMMARY Some embodiments advantageously provide methods and apparatuses for 5G Multicast/Broadcast Multimedia Subsystem (5MBS) individual delivery.

In one embodiment, an access and mobility management function, AMF, node or other core network node is configured to obtain a radio access network, RAN, capability indication; and as a result of a request from a user equipment, UE, to join a multicast/broadcast, MB, session, send a MB session response, the MB session response including one of a rejection to the request to join and an acceptance of the request to join based at least in part on at least one of the RAN capability indication, a disable individual delivery parameter related to a multicast broadcast service, MBS, and a policy.

In one embodiment, an application function, AF, node is configured to determine whether to disable individual multicast broadcast service, MBS, traffic delivery for a multicast/broadcast, MB, session to at least one user equipment, UE; and set and/or send a disable individual delivery parameter associated with the MB session based at least in part on the determination.

According to an aspect of the present disclosure, a method implemented in a core network node is provided. The method includes determining a radio access network, RAN, capability indication; and as a result of a request from a user equipment, UE, to join a multicast/broadcast, MB, session, sending a MB session response, the MB session response including one of a rejection to the request to join and an acceptance of the request to join based on the RAN capability indication and further based on at least one of a disable individual delivery parameter related to a multicast broadcast service, MBS, and a policy.

In some embodiments of this aspect, the determining the RAN capability indication comprises one of: obtaining the RAN capability indication from a second network node; and internally deriving the RAN capability indication. In some embodiments of this aspect, the disable individual delivery parameter indicates whether an application function, AF, node one of enabled and disabled individual MBS traffic delivery for the MB session that the UE requested to join. In some embodiments of this aspect, the request to join the MB session includes at least one of: the RAN capability indication and an identification of the requested MB session; and the identification of the requested MB session includes a Temporary Mobile Group Identity, TMGI, allocated to the MB session.

In some embodiments of this aspect, the RAN capability indication indicates whether a RAN node that the UE is associated with supports a multicast broadcast service, MBS. In some embodiments of this aspect, the RAN capability indication is determined based on the UE's request to join the MB session. In some embodiments of this aspect, the RAN capability indication is determined based on the RAN node's response to the network node requesting to check the RAN capability or as part of a set-up procedure. In some embodiments of this aspect, each of the request to join and the response is in a non-access stratum, NAS, message. In some embodiments of this aspect, the MB session response includes a cause code indicating at least one of information about the RAN capability and information about individual multicast broadcast service, MBS, traffic delivery. In some embodiments of this aspect, the core network node is a Session Management Function, SMF.

According to another aspect, a method implemented in an application function, AF, node is provided. The method includes determining whether to disable an individual multicast broadcast service, MBS, traffic delivery for a multicast/broadcast, MB, session to at least one user equipment, UE; and sending to a network node a disable individual delivery parameter associated with the MB session based at least in part on the determination.

In some embodiments of this aspect, the determining is based at least in part on a characteristic of an application associated with the MB session. In some embodiments of this aspect, the disable individual delivery parameter indicates whether the AF node one of enabled and disabled an individual traffic delivery for the MB session. In some embodiments of this aspect, the individual traffic delivery is an individual multicast broadcast service, MBS, traffic delivery for the MB session.

According to an aspect of the present disclosure, a network node is provided. The network node includes processing circuitry configured to cause the network node to determine a radio access network, RAN, capability indication; and as a result of a request from a user equipment, UE, (12) to join a multicast/broadcast, MB, session, send a MB session response, the MB session response including one of a rejection to the request to join and an acceptance of the request to join based on the RAN capability indication and further based on at least one of a disable individual delivery parameter related to a multicast broadcast service, MBS, and a policy.

In some embodiments of this aspect, the processing circuitry is configured to cause the network node to the determine the RAN capability indication by being configured to cause the network node to one of: obtain the RAN capability indication from a second network node; and internally derive the RAN capability indication. In some embodiments of this aspect, the disable individual delivery parameter indicates whether an application function, AF, node one of enabled and disabled individual MBS traffic delivery for the MB session that the UE requested to join. In some embodiments of this aspect, the request to join the MB session includes at least one of: the RAN capability indication and an identification of the requested MB session; and the identification of the requested MB session includes a Temporary Mobile Group Identity, TMGI, allocated to the MB session.

In some embodiments of this aspect, the RAN capability indication indicates whether a RAN node that the UE is associated with supports a multicast broadcast service, MBS. In some embodiments of this aspect, the RAN capability indication is determined based on the UE's request to join the MB session. In some embodiments of this aspect, the RAN capability indication is determined based on the RAN node's response to the network node requesting to check the RAN capability or as part of a set-up procedure. In some embodiments of this aspect, each of the request to join and the response is in a non-access stratum, NAS, message. In some embodiments of this aspect, the MB session response includes a cause code indicating at least one of information about the RAN capability and information about individual multicast broadcast service, MBS, traffic delivery. In some embodiments of this aspect, the core network node is a Session Management Function, SMF.

According to an aspect of the present disclosure, an application function, AF, node is provided. The AF node includes processing circuitry configured to cause the AF node to determine whether to disable an individual multicast broadcast service, MBS, traffic delivery for a multicast/broadcast, MB, session to at least one user equipment, UE; and send to a network node a disable individual delivery parameter associated with the MB session based at least in part on the determination.

In some embodiments of this aspect, the processing circuitry is configured to cause the network node to the determine at least in part on a characteristic of an application associated with the MB session. In some embodiments of this aspect, the disable individual delivery parameter indicates whether the AF node one of enabled and disabled an individual traffic delivery for the MB session. In some embodiments of this aspect, the individual traffic delivery is an individual multicast broadcast service, MBS, traffic delivery for the MB session.

In another aspect, a computer readable medium comprising computer instructions executable by processing circuitry to perform any one or more of the methods herein is provided.

According to yet another aspect, a system is provided. The system includes an application function, AF, node and a core network node. The AF node is configured to determine whether to disable an individual multicast broadcast service, MBS, traffic delivery for a multicast/broadcast, MB, session; and send a disable individual delivery parameter associated with the MB session based at least in part on the determination. The core network node is configured to receive the disable individual delivery parameter from the AF node; determine a radio access network, RAN, capability indication; and as a result of a request from a user equipment, UE, to join the MB session, send a MB session response, the MB session response including one of a rejection to the request to join and an acceptance of the request to join based on the RAN capability indication and further based on at least one of the disable individual delivery parameter and a policy.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram showing an example of delivery methods;

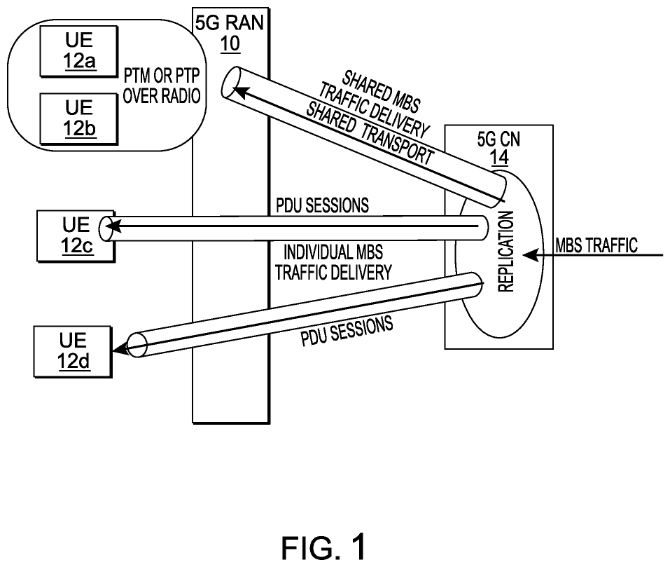

FIG. 2 is a call flow diagram illustrating an example session start;

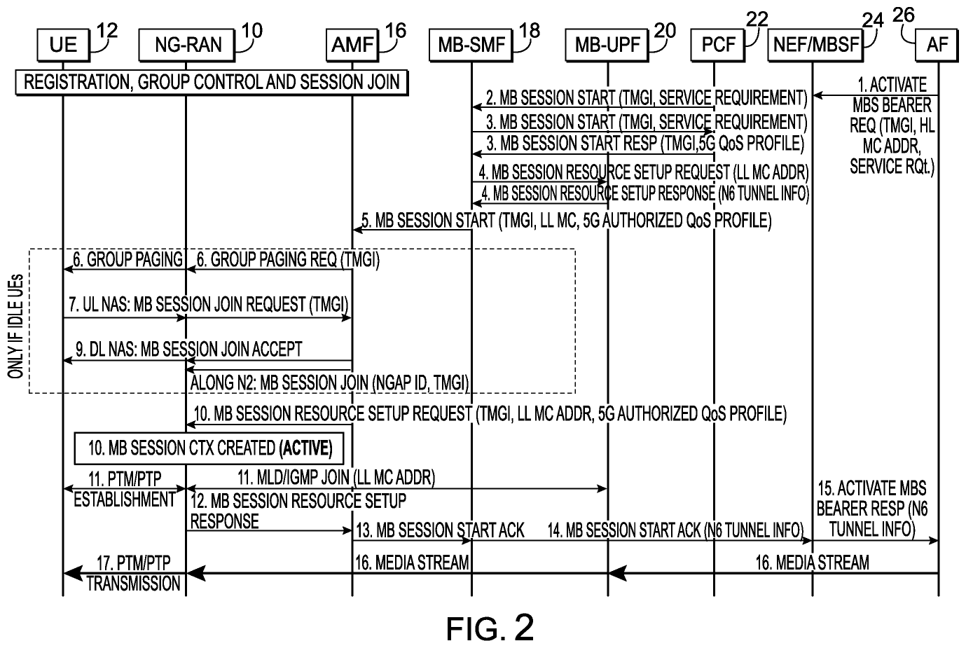

FIG. 3 is a call flow diagram illustrating an example PDU session modification for multicast;

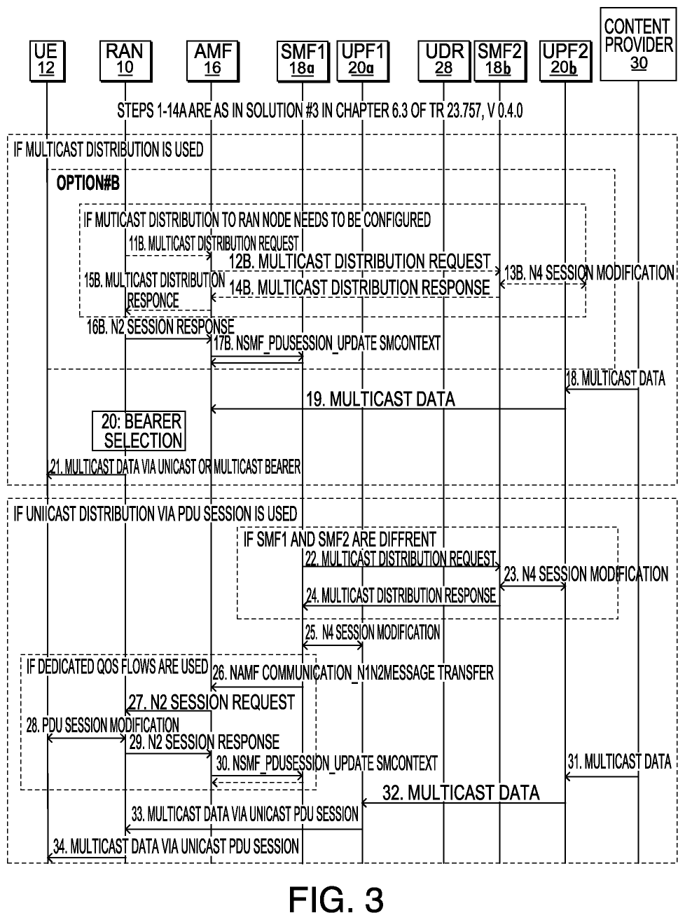

FIG. 4 illustrates an example system architecture according to some embodiments of the present disclosure;

FIG. 5 illustrates yet another example system architecture and example hardware arrangements for devices in the system, according to some embodiments of the present disclosure;

FIG. 6 is a flowchart of an example process in a core network node (e.g., AMF node, SMF node or any other core network node) according to some embodiments of the present disclosure;

FIG. 7 is a flowchart of an example process in a network node (e.g., AF node or any other network node) according to some embodiments of the present disclosure;

FIG. 8 is a flowchart of an example process in a core network node (e.g., AMF node, SMF node or any other core network node) according to some embodiments of the present disclosure;

FIG. 9 is a flowchart of an example process in a network node (e.g., AF node or any other network node) according to some embodiments of the present disclosure;

FIG. 10 is a call flow diagram illustrating an example session join procedure prior to a start session according to some embodiments of the present disclosure;

FIG. 11 is a call flow diagram illustrating an example start session procedure according to some embodiments of the present disclosure; and

FIG. 12 is a call flow diagram illustrating an example session join procedure after a start session according to some embodiments of the present disclosure.

### DETAILED DESCRIPTION

As stated above, Solution #2 has drawbacks since it does not support “5GC Individual MBS traffic delivery”. As a result, the possible improvement of minimizing packet loss for MBS traffic at UE handover from NG-RAN supporting 5MBS to NG-RAN not supporting 5MBS or to E-UTRAN may not be possible.

In addition, the “5GC Individual MBS traffic delivery” may be beneficial in some use cases (e.g., mission critical push-to-talk, Internet Protocol Television (IPTV), etc.) when there is no homogenous 5MBS support; however, for some other use cases, e.g., smart TV, it may not be the best option, since “5GC Individual MBS traffic delivery” conveys the same content that is delivered over 5MBS bearers. The drawback with that compared to unicast delivery over normal PDU Sessions, may be e.g., that individual control of bitrate, retransmission, etc. may not be possible. In addition, the 5MBS content does sometimes have extra redundant information, sometimes referred to as Forward Error Correction (FEC) information, which may be omitted when unicast over normal PDU Sessions are used. For some applications, it may be useful to be able to disable the use of “5GC Individual MBS traffic delivery.

Some embodiments of the present disclosure enable the possibility of enabling/disabling “5GC Individual MBS traffic delivery method” or in this document also called “5MBS Individual Delivery”. When Shared Delivery of 5MBS service cannot be used in a NG-RAN node, e.g. due to that the NG-RAN node does not support 5MBS services, the 5GC can switch and instead deliver the 5MBS service and content over a normal PDU Session to that UE when camping on that NG-RAN node.

In some embodiments, the AF can decide whether to utilize “5MBS Individual Delivery” based on the characteristics of the application and the AMF or network (e.g., any core network node) can decide whether to utilize “5MBS Individual Delivery” based on network preferences and/or policies.

In some embodiments, when a UE requests to join a 5MBS Session, the proposed solution enables the AMF or other core network node to accept the join request, or initiate the “5MBS Individual Delivery” method, or reject the join request, depending on if 5MBS is supported in the NG-RAN node or not and/or depending on AF indication, network preferences and/or policies.

Furthermore, some embodiments enable the AMF or other core network node to detect a RAN's capability of 5MBS support. Based on such indication of the RAN's capability of 5MBS support, the AMF or other core network node can take different actions in different scenarios:
If a RAN supports 5MBS, the AMF, or other core network node triggers the 5GC Shared MBS traffic delivery method;
If a RAN does not support 5MBS, and the AF enables “5MBS Individual Delivery” and network preferences and policies allow the “5MBS Individual Delivery”, the AMF, or other core network node may use the “5MBS Individual Delivery” and deliver the 5MBS content over a PDU session to the UE;
If a RAN does not support 5MBS and the AF disables “5MBS Individual Delivery”, the AMF, or other core network node may reject the UE MB Session Join request, and allow UE to contact AF via unicast (i.e., without using any of the 5GC controlled “MBS traffic delivery methods”).

Some embodiments of the present disclosure implement the “5MBS Individual Delivery” in e.g., Solution #2 of TR 23.757 v0.4.0 by means of e.g., the PDU Session Anchor (PSA) UPF joining the multicast tree of MB-UPF without exchanging information between the controlling entities (i.e., SMF and MB-SMF) of the UPFs, which may be considered a simpler way as compared with the Solution #3.

Some embodiments of the present disclosure implement the “5MBS Individual Delivery” in e.g., Solution #2 of TR 23.757 v0.4.0 without requiring pre-establishment of a PDU Session when 5MBS services are used. (Solution 3 has such a prerequisite). Such a prerequisite may make the system complexity higher. Without such a prerequisite, as in this solution, the handling MB Sessions and PDU Session can be more decoupled resulting in lower system complexity.

Some embodiments of the present disclosure enable the possibility of enabling/disabling “5MBS Individual Delivery” from the AF. In some embodiments, the AF can determine whether “5MBS Individual Delivery” should be allowed or not based on e.g., the characteristics of the application associated with the AF. The AMF or other core network node may then make the final decision whether to utilize “5MBS Individual Delivery” based on e.g., one or more of NG-RAN capabilities, network preferences and policies and AF preference.

Some embodiments of the present disclosure may allow the AMF or other core network node to deliver 5MBS service to a UE camping on a NG-RAN node that does not support 5MBS. Instead of rejecting a UE 5MBS Join Request when NG-RAN does not support 5MBS, the AMF or other core network node may apply the “5MBS Individual Delivery” and accept the Join Request.

Several possibilities to allow the AMF or other core network node to discover the 5MBS capability of the NG-RAN are outlined in the present disclosure, as described in detail below.

Before describing in detail exemplary embodiments, it is noted that the embodiments reside primarily in combinations of apparatus components and processing steps related to 5G Multicast/Broadcast Multimedia Subsystem (5MBS) individual delivery. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

In some embodiments, the non-limiting terms wireless device (WD) or a user equipment (UE) are used interchangeably. The UE herein can be any type of wireless device capable of communicating with a network node or another UE over radio signals. In some embodiments, the UE may be or include a mobile entity (ME). The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, integrated access and backhaul (IAB), donor node controlling relay, radio access point (AP), transmission points, transmission nodes, Remote Radio Unit (RRU) Remote Radio Head (RRH), a core network node (e.g., an Access and Mobility Function (AMF), a Session Management Function (SMF) and/or an SMF dedicated for or supporting Multicast Broadcast which is referred to herein as MB-SMF), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) or a radio network node.

In some embodiments, the term “node” is used herein and can be any kind of network node, such as, an AMF node or other core network node, an AF node, etc.

A node may include physical components, such as processors, allocated processing elements, or other computing hardware, computer memory, communication interfaces, and other supporting computing hardware. The node may use dedicated physical components, or the node may be allocated use of the physical components of another device, such as a computing device or resources of a datacenter, in which case the node is said to be virtualized. A node may be associated with multiple physical components that may be located either in one location, or may be distributed across multiple locations.

In some embodiments, the terms “individual delivery”, “individual MBS delivery” and “individual 5MBS delivery” are used interchangeably. In some embodiments, the terms “capability indication”, “RAN capability indication” and “capability of RAM to support 5MBS” are used interchangeably.

The term “individual delivery” may be used to indicate 5GC Individual MBS traffic delivery where a 5G core network (CN) receives a single copy of MBS data packets and delivers separate copies of those MBS data packets to individual UEs via per-UE PDU sessions, hence for each such UE one PDU session is required to be associated with a multicast session.

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

In some embodiments, the term “obtain” or “obtaining” is used herein and may indicate obtaining in e.g., memory such as in the case where the information is predefined or pre-configured. The term “obtain” or “obtaining” as used herein may also indicate obtaining by receiving signaling/message indicating the information obtained.

Although certain terms are used in this disclosure for certain proposed elements (e.g., DisableIndividualDelivery parameter, CheckRANCapability request and response messages), it is contemplated that such elements may be given another name in, for example, a standardization document; thus, the disclosure is not limited to the particular names used.

Any two or more embodiments described in this disclosure may be combined in any way with each other.

Note also that some embodiments of the present disclosure may be supported by standard documents disclosed in Third Generation Partnership Project (3GPP) technical specifications. That is, some embodiments of the description can be supported by the above documents. In addition, all the terms disclosed in the present document may be described by the above standard documents.

Note that although terminology from one particular wireless system, such as, for example, 3^{rd} Generation Partnership Project (3GPP), Long Term Evolution (LTE), 5^{th} Generation (5G) (also known as New Radio (NR)), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a UE, AMF node or any other core network node and an AF node may be distributed over a plurality of UEs, a plurality of AMF nodes, a plurality of AF nodes or a plurality of core network nodes. In other words, it is contemplated that the functions of the UE, AMF node or other core network node, AF node described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

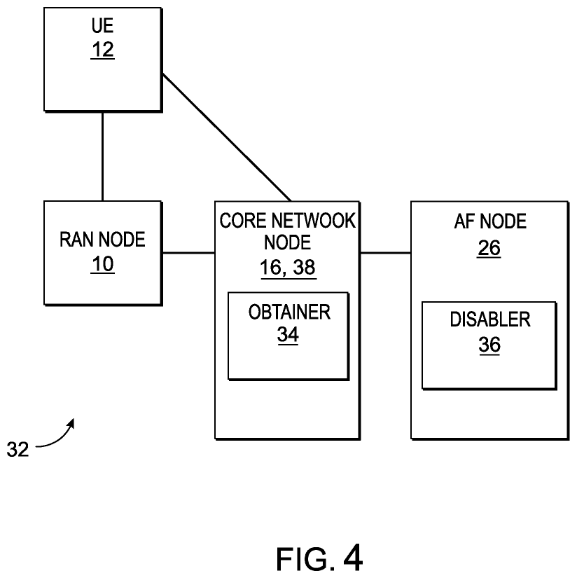

Referring again to the drawing figures, in which like elements are referred to by like reference numerals, there is shown in FIG. 4 a schematic diagram of a communication system 32, according to an embodiment, constructed in accordance with the principles of the present disclosure. The communication system 32 in FIG. 4 is a non-limiting example and other embodiments of the present disclosure may be implemented by one or more other systems and/or networks. Referring to FIG. 4, the system 32 includes an obtainer 34 and a disabler 36. The obtainer 34 may be configured to cause the AMF node 16 or other core network node 38 to obtain a radio access network, RAN, capability indication; and as a result of a request from a user equipment, UE, to join a multicast/broadcast, MB, session, sending a MB session response, the MB session response including one of a rejection to the request to join and an acceptance of the request to join based at least in part on at least one of the RAN capability indication, a disable individual delivery parameter related to a multicast broadcast service, MBS, and a policy. It is noted that the core network node (38) may comprise an AMF 16, an SMF 18a and/or an MB-SMF 18b. The disabler 36 may be configured to cause the AF node 26 to determine whether to disable individual multicast broadcast service, MBS, traffic delivery for a multicast/broadcast, MB, session to at least one user equipment, UE; and set and/or send a disable individual delivery parameter associated with the MB session based at least in part on the determination.

The system 32 further includes a UE 12, a radio access network (RAN) 10 (e.g., 3GPP 5^{th} Generation (5G) RAN also known as New Radio or NR RAN), which may provide radio access to the UE 12. The system 32 includes an Access and Mobility Management Function (AMF) node or one or more other core network nodes 16, 38. The system 32 includes an AF node 26. In some embodiments, the AF node 26 may be considered to support application influence on traffic routing, accessing NEF, interaction with policy framework for policy control, etc. It should be noted that, for simplicity, a single node is shown for the various entities in the system 32 depicted in FIG. 4 (e.g., a single UE 12, a single RAN 10, a single AMF node or other core network node 16, 38, a single AF node 26, etc.); however, it should be understood that the system 32 may include numerous entities/nodes of those shown in FIG. 4, as well as, additional entities/nodes not shown in FIG. 4. In addition, the system 32 may include many more connections than those shown in FIG. 4.

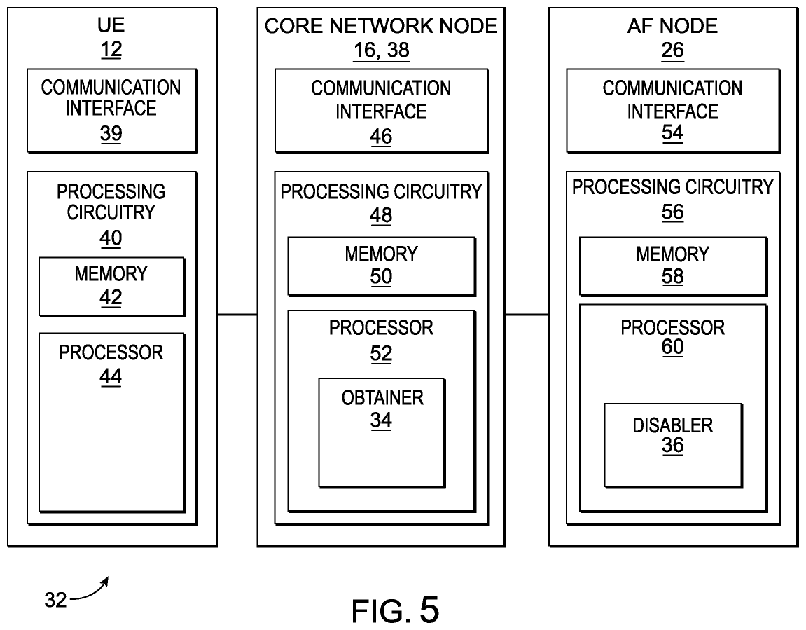

Example implementations, in accordance with an embodiment, of the UE 12, AMF node or other core network node 16, 38 and AF node 26 discussed in the preceding paragraphs will now be described with reference to FIG. 5.

The UE 12 includes a communication interface 39, processing circuitry 40, and memory 42. The communication interface 39 may be formed as or may include, for example, one or more radio frequency (RF) transmitters, one or more RF receivers, and/or one or more RF transceivers, and/or may be considered a radio interface. In some embodiments, the communication interface 39 may also include a wired interface.

The processing circuitry 40 may include one or more processors 44 and memory, such as, the memory 42. In particular, in addition to a traditional processor and memory, the processing circuitry 40 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) the memory 42, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UE 12 may further include software stored internally in, for example, memory 42, or stored in external memory (e.g., database) accessible by the UE 12 via an external connection. The software may be executable by the processing circuitry 40. The processing circuitry 40 may be configured to control any of the methods and/or processes described herein and/or to cause such methods, and/or processes to be performed, e.g., by the UE 12. The memory 42 is configured to store data, programmatic software code and/or other information described herein. In some embodiments, the software may include instructions stored in memory 42 that, when executed by the processor 44 causes the processing circuitry 40 and/or configures the UE 12 to perform the processes described herein with respect to the UE 12.

The AMF node or other core network node 16, 38 includes a communication interface 46, processing circuitry 48, and memory 50. The communication interface 46 may be formed as or may include, for example, one or more radio frequency (RF) transmitters, one or more RF receivers, and/or one or more RF transceivers, and/or may be considered a radio interface. In some embodiments, the communication interface 46 may also include a wired interface.

The processing circuitry 48 may include one or more processors 52 and memory, such as, the memory 50. In particular, in addition to a traditional processor and memory, the processing circuitry 48 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) the memory 50, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

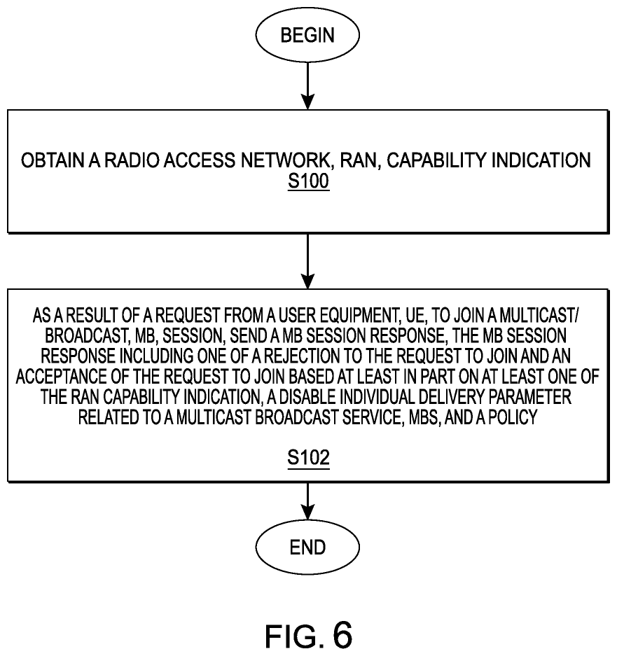

Thus, the AMF node or other core network node 16, 38 may further include software stored internally in, for example, memory 50, or stored in external memory (e.g., database) accessible by the AMF node or other core network node 16, 38 via an external connection. The software may be executable by the processing circuitry 48. The processing circuitry 48 may be configured to control any of the methods and/or processes described herein and/or to cause such methods, and/or processes to be performed, e.g., by the AMF node or other core network node 16, 38. The memory 50 is configured to store data, programmatic software code and/or other information described herein. In some embodiments, the software may include instructions stored in memory 50 that, when executed by the processor 52 and/or obtainer 34, causes the processing circuitry 48 and/or configures the AMF node or other core network node 16, 38 to perform the processes described herein with respect to the AMF node or other core network node 16, 38 (e.g., processes described with reference to FIG. 6 and/or any of the other figures).

The AF node 26 includes a communication interface 54, processing circuitry 56, and memory 58. The communication interface 54 may be formed as or may include, for example, one or more radio frequency (RF) transmitters, one or more RF receivers, and/or one or more RF transceivers, and/or may be considered a radio interface. In some embodiments, the communication interface 54 may also include a wired interface.

The processing circuitry 56 may include one or more processors 60 and memory, such as, the memory 58. In particular, in addition to a traditional processor and memory, the processing circuitry 56 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 60 may be configured to access (e.g., write to and/or read from) the memory 58, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

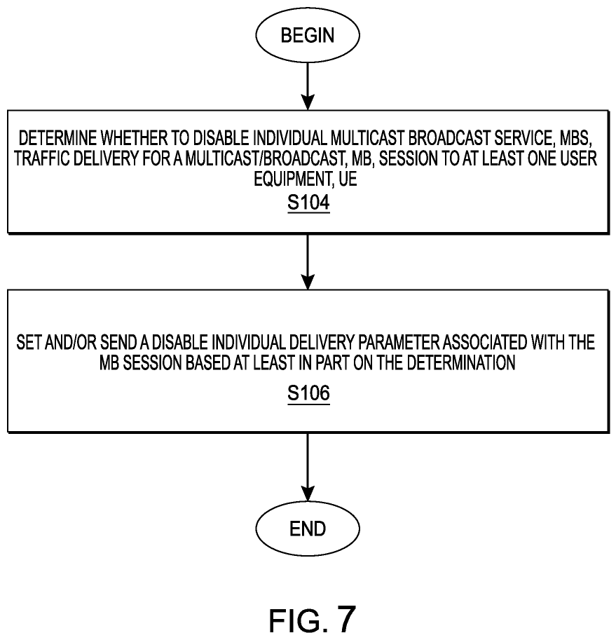

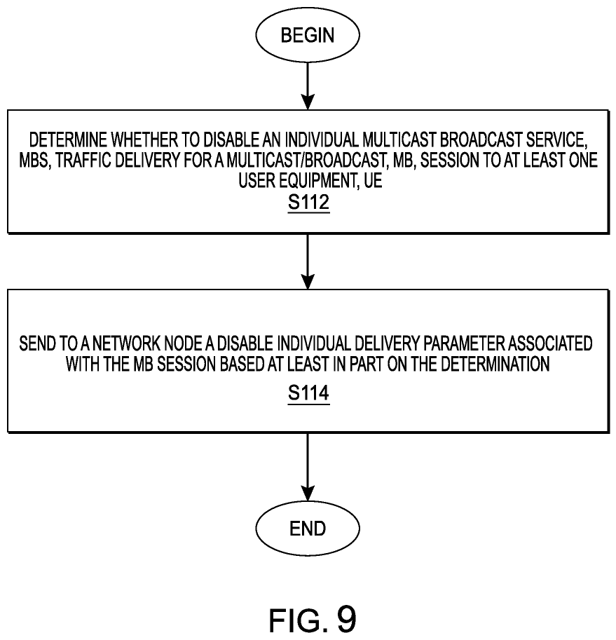

Thus, the AF node 26 may further include software stored internally in, for example, memory 58, or stored in external memory (e.g., database) accessible by the AF node 26 via an external connection. The software may be executable by the processing circuitry 56. The processing circuitry 56 may be configured to control any of the methods and/or processes described herein and/or to cause such methods, and/or processes to be performed, e.g., by the AF node 26. The memory 58 is configured to store data, programmatic software code and/or other information described herein. In some embodiments, the software may include instructions stored in memory 58 that, when executed by the processor 60 and/or disabler 36, causes the processing circuitry 56 and/or configures the AF node 26 to perform the processes described herein with respect to the AF node 26 (e.g., processes described with reference to FIGS. 7, 9 and/or any of the other figures).

In FIG. 5, the connection between the devices UE 12, AMF node or other core network node 16, 38, and AF node 26 is shown without explicit reference to any intermediary devices or connections. However, it should be understood that intermediary devices and/or connections may exist between these devices, although not explicitly shown. Also, although FIG. 5 shows the various devices, e.g., UE 12, AMF node or other core network node 16, 38, and AF node 26, connected in serial fashion, this arrangement is solely for ease of understanding. It is understood that one or more of the UE 12, AMF node or other core network node 16, 38, and AF node 26 may communicate via a cloud network and not in a serial manner.

Although FIG. 5 shows obtainer 34 and disabler 36 as being within a respective processor, it is contemplated that these elements may be implemented such that a portion of the elements is stored in a corresponding memory within the processing circuitry. In other words, the elements may be implemented in hardware or in a combination of hardware and software within the processing circuitry.

FIG. 6 is a flowchart of an example process in an AMF node or other core network node 16, 38 according to some embodiments of the present disclosure. One or more Blocks and/or functions and/or methods performed by AMF node or other core network node 16, 38 may be performed by one or more elements of AMF node or other core network node 16, 38 such as by obtainer 34 in processing circuitry 48, processor 52, memory 50, communication interface 46, etc. The example method includes obtaining (Block S100), such via obtainer 34, processing circuitry 48, processor 52, memory 50 and/or communication interface 46, a radio access network, RAN, capability indication; and as a result of a request from a user equipment, UE, to join a multicast/broadcast, MB, session, sending (Block S102), such via obtainer 34, processing circuitry 48, processor 52, memory 50 and/or communication interface 46, a MB session response, the MB session response including one of a rejection to the request to join and an acceptance of the request to join based at least in part on at least one of the RAN capability indication, a disable individual delivery parameter related to a multicast broadcast service, MBS, and a policy.

In some embodiments, the disable individual delivery parameter indicates whether an application function, AF, node one of enabled and disabled individual MBS traffic delivery for the MB session that the UE requested to join. In some embodiments, the request to join the MB session includes at least one of: the RAN capability indication and an identification of the requested MB session. In some embodiments, the identification of the requested MB session includes a Temporary Mobile Group Identity, TMGI, allocated to the MB session. In some embodiments, the RAN capability indication indicates whether the RAN that the UE is associated with supports a 3^{rd} Generation Partnership Project, 3GPP, 5^{th} Generation, 5G, multicast broadcast service, 5MBS. In some embodiments, the RAN capability indication is obtained from the UE's request to join the MB session.

In some embodiments, the RAN capability indication is obtained, such via obtainer 34, processing circuitry 48, processor 52, memory 50 and/or communication interface 46, from the RAN responsive to the AMF node or other core network node 16, 38 requesting to check the RAN capability or as part of a set-up procedure. In some embodiments, each of the request to join and the response is sent in a non-access stratum, NAS, message to the AMF node or other core network node 16, 38. In some embodiments, the MB session response includes a cause code indicating at least one of information about the RAN capability and information about individual 5MBS traffic delivery.

In some embodiments, as a result of the request to join the MB session, at least one of: selecting a protocol data unit, PDU, session for individual 5MBS traffic delivery to the UE for the MB session; when the AMF node or other core network node 16, 38 is unable to identify an existing PDU session for the UE, one of: triggering the UE to establish a PDU session for the AMF node or other core network node 16, 38 to select; and transmitting the MB session response comprising the rejection to the request to join; sending a session resource set-up request to the RAN node along with an address associated with the MB session; obtaining a session management context for the selected PDU session; and determining whether to participate in providing individual 5MBS traffic delivery associated with the MB session to the UE, based at least in part on at least one of the RAN capability indication, the disable individual delivery parameter associated with the MB session and the policy associated with the AMF node or other core network node 16, 38.

FIG. 7 is a flowchart of an example process in an AF node 26 according to one or more of the techniques in the present disclosure. One or more Blocks and/or functions and/or methods performed by the AF node 26 may be performed by one or more elements of AF node 26 such as by disabler 36 in processing circuitry 56, memory 58, processor 60, communication interface 54, etc. according to the example process/method. The example method includes determining (Block S104), such as via disabler 36, processing circuitry 56, memory 58, processor 60 and/or communication interface 54, whether to disable individual multicast broadcast service, MBS, traffic delivery for a multicast/broadcast, MB, session to at least one user equipment, UE. The method includes setting and/or sending (Block S106), such as via disabler 36, processing circuitry 56, memory 58, processor 60 and/or communication interface 54, a disable individual delivery parameter associated with the MB session based at least in part on the determination.

In some embodiments, determining, such as via disabler 36, processing circuitry 56, memory 58, processor 60 and/or communication interface 54, is based at least in part on a characteristic of an application associated with the MB session. In some embodiments, the disable individual delivery parameter indicates whether the AF node one of enabled and disabled the individual traffic delivery for the MB session. In some embodiments, the individual traffic delivery is an individual 3^{rd} Generation Partnership Project, 3GPP, 5^{th} Generation, 5G, multicast broadcast service, 5MBS, traffic delivery. In some embodiments, the method further includes transmitting, such as via disabler 36, processing circuitry 56, memory 58, processor 60 and/or communication interface 54, content associated with the MB session for the UE using one of the individual 5MBS traffic delivery and a unicast delivery to the UE, based at least in part on at least one of a radio access network, RAN, capability, the disable individual delivery parameter associated with the MB session and a policy associated with access and mobility management function, AMF, node or other core network node 16, 38.

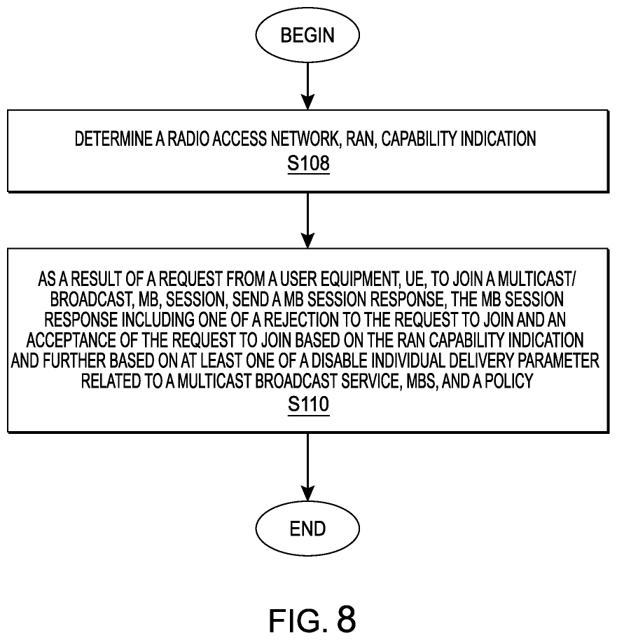

FIG. 8 is a flowchart of an example process in an AMF node or other core network node 16, 38 according to some embodiments of the present disclosure. One or more Blocks and/or functions and/or methods performed by an AMF node or other core network node 16, 38 may be performed by one or more elements of AMF node or other core network node 16, 38 such as by communication interface 46, processing circuitry 48, memory 50, processor 52, etc. The example method includes determining (S108), such as via communication interface 46, processing circuitry 48, memory 50 and/or processor 52, a radio access network, RAN, capability indication. The method includes as a result of a request from a user equipment, UE, 12 to join a multicast/broadcast, MB, session, sending (S110), such as via communication interface 46, processing circuitry 48, memory 50 and/or processor 52, a MB session response, the MB session response including one of a rejection to the request to join and an acceptance of the request to join based on the RAN capability indication and further based on at least one of a disable individual delivery parameter related to a multicast broadcast service, MBS, and a policy.

In some embodiments, the determining the RAN capability indication comprises one of: obtaining, such as via communication interface 46, processing circuitry 48, memory 50 and/or processor 52, the RAN capability indication from a second network node; and internally deriving, such as via communication interface 46, processing circuitry 48, memory 50 and/or processor 52, the RAN capability indication. In some embodiments, the disable individual delivery parameter indicates whether an application function, AF, node 26 one of enabled and disabled individual MBS traffic delivery for the MB session that the UE 12 requested to join. In some embodiments, the request to join the MB session includes at least one of: the RAN capability indication and an identification of the requested MB session; and the identification of the requested MB session includes a Temporary Mobile Group Identity, TMGI, allocated to the MB session.

In some embodiments, the RAN capability indication indicates whether a RAN node 10 that the UE 12 is associated with supports a multicast broadcast service, MBS. In some embodiments, the RAN capability indication is determined based on the UE's 12 request to join the MB session. In some embodiments, the RAN capability indication is determined based on the RAN node's 10 response to the AMF or other core network node 16, 38 requesting to check the RAN capability or as part of a set-up procedure. In some embodiments, each of the request to join and the response is in a non-access stratum, NAS, message. In some embodiments, the MB session response includes a cause code indicating at least one of information about the RAN capability and information about individual MBS traffic delivery.

FIG. 9 is a flowchart of an example process in an AF node 26 according to one or more of the techniques in the present disclosure. One or more Blocks and/or functions and/or methods performed by the AF node 26 may be performed by one or more elements of AF node 26 such as by disabler 36 in processing circuitry 56, memory 58, processor 60, communication interface 54, etc. according to the example process/method. The example method includes determining (Block S112), such as via disabler 36, processing circuitry 56, memory 58, processor 60 and/or communication interface 54, whether to disable an individual multicast broadcast service, MBS, traffic delivery for a multicast/broadcast, MB, session to at least one user equipment, UE 12. The method includes sending (S114), such as via disabler 36, processing circuitry 56, memory 58, processor 60 and/or communication interface 54, to a network node 38 a disable individual delivery parameter associated with the MB session based at least in part on the determination.

In some embodiments, the determining, such as via disabler 36, processing circuitry 56, memory 58, processor 60 and/or communication interface 54, is based at least in part on a characteristic of an application associated with the MB session. In some embodiments, the disable individual delivery parameter indicates whether the AF node 26 one of enabled and disabled an individual traffic delivery for the MB session. In some embodiments, the individual traffic delivery is an individual multicast broadcast service, MBS, traffic delivery for the MB session.

Having generally described arrangements for Multicast/Broadcast Multimedia Subsystem (MBS) individual delivery, a more detailed description of some of the embodiments are provided as follows with reference to FIGS. 8-10, and which may be implemented by UE 12, AMF node or other core network node 16, 38, and/or AF node 26.

Additionally, although some of the examples of the solution proposed by the present disclosure may be described as enhancements to Solution #2 and Architecture Option #2 in TR 23.757 v0.4.0, the principles disclosed may be applicable and/or beneficial for other solutions or other architectures. For example, one or more functions shown as being performed by one particular core network node, such as AMF or SMF, may be performed by one or more other of the core network nodes.

### Procedure of Session Join Prior to Session Start in 5MBS

Some embodiments of the present disclosure introduce a new parameter, which is referred to herein interchangeably as “DisableIndividualDelivery” or “disable individual delivery” parameter. In some embodiments, the DisableIndividualDelivery parameter may indicate whether the AF node 26 expects the 5G System (5GS) to enable the 5MBS individual delivery method. For example:
If DisableIndividualDelivery is true, AF node 26 indicates to the 5G Core (5GC) that shared delivery should not be applied or is not expected by AF node 26. If 5MBS service cannot be provided by 5GC, the AF node 26 may itself establish the Quality-of-Service (QoS) flow and deliver the 5MBS content to the UE 12 over unicast, i.e., over a PDU Session.
If DisableIndividualDelivery is not indicated by the AF node 26 or is set to false, the 5GC may establish individual delivery for the UE 12 e.g., if warranted and possible.

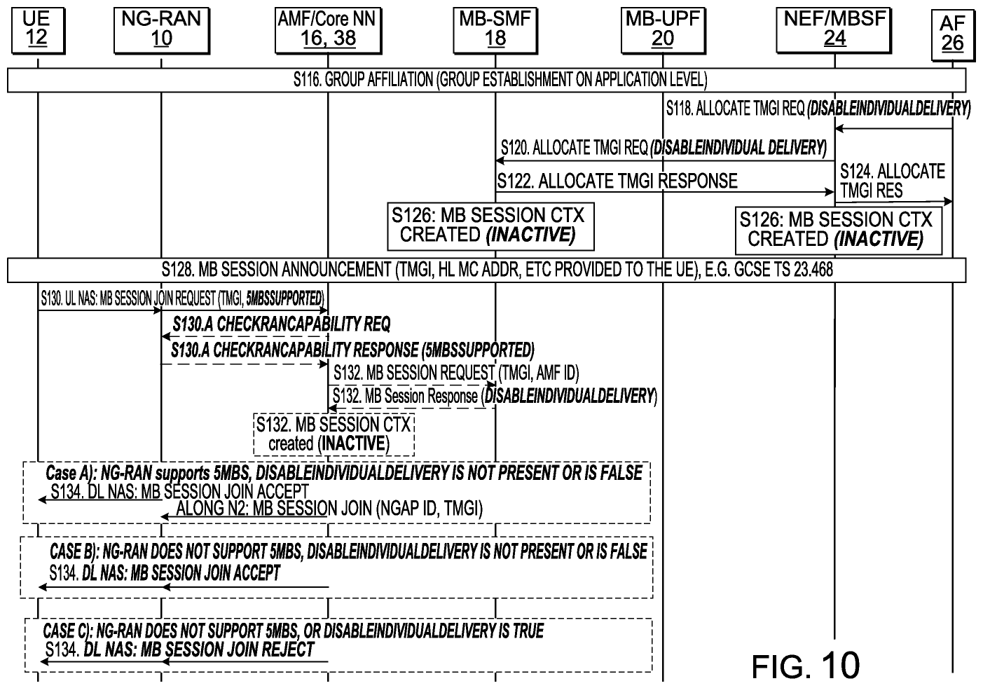

The example sequence flow in FIG. 10 illustrates the 5MBS session creation procedure and illustrates that the UE 12 may join the 5MBS session prior to the session start. The sequence flow may includes one or more of the following steps:
The following steps may be performed after the UE 12 registers to the 5GS and establishes a PDU session (e.g. for app signalling);
Step S116: Group affilation may be performed.
Steps S118-S120: when AF node 26 determines to a create Multicast/Broadcast (MB) session via “Allocate Temporary Mobile Group Identity (TMGI) Request”, AF node 26 passes/transmits the DisableIndividualDelivery parameter to NEF/MBSF node 24. And NEF/MBSF node 24 passes/transmits the information to MB-SMF node 18.
Step S122-S124: MB-SMF node 18 allocates a TMGI for the MB session and responds with the allocated TMGI to AF node 26 via NEF/MBSF node 24.
Step S126: MB Session is created (inactive).
Step S128: AF node 26 performs a service announcement to UE(s) 12.
Step S130: UE 12 sends a non-access stratum (NAS) message request to join an MB session to AMF/core network node 16, 38, e.g., MB Session Join Request message including the TMGI parameter. The TMGI parameter indicates the session that the UE 12 is requesting to join. In some embodiments, NG-RAN node 10 may broadcast an indicator of whether 5MBS is supported over the air. If the indicator is broadcasted, the UE 12 may include such information in a 5MBSSupported parameter as an example, in the MB Session Join Request. In this embodiment, the capability discovery in step 130.A may be skipped.

Note: In this step, “MB Session Join Request” is merely an example. It could be called “MB Service Request”, “MBS Service Request” or the existing “Service Request” with new parameters indicating an MB session, e.g., a TMGI.
Step S130.A: If UE 12 does not include 5MBSSupported capability indication/parameter of the NG-RAN node 10 in the MB Session Join Request, AMF/core network node 16, 38 may check the RAN node's 10 capability of whether 5MBS is supported. For example, AMF/core network node 16, 38 may send a Next Generation Application Protocol (NGAP) message Check RAN Capability Request to NG-RAN node 10 to query the capability, and NG-RAN node 10 may include the information of whether 5MBS is supported in a Check RAN Capability Response.

There are several embodiments to enable the AMF/core network node 16, 38 to discover the NG-RAN node's 10 5MBS capability, such as, for example:
i. Embodiment 1: in step S130, UE 12 discovers the 5MBS capability and provides a capability indicator to AMF/core network node 16, 38 in the NAS message.
ii. Embodiment 2: In step S130, it is also possible to allow the NG-RAN node 10 to transmit its 5MBS capability information as part of the NGAP message which is used to forward the NAS message to the AMF/core network node 16, 38.
iii. Embodiment 3: In step S130.A., an explicit NGAP request/response messages enables AMF/core network node 16, 38 to query the NG-RAN node 10 of its 5MBS capability.
iv. Embodiment 4: It is also possible to let NG-RAN node 10 to transmit the capability information as part of the NGAP setup, i.e., performed once when the particular NG-RAN node 10 first learns about the AMF/core network node 16, 38 (e.g., during registration).
v. Embodiment 5: Yet another embodiment is to have NG-RAN node's 10 5MBS capability information configured in the AMF/core network node 16, 38.
Step S132: If AMF/core network node 16, 38 does not have the 5MBS session context, AMF/core network node 16, 38 may query MB-SMF node 18 via e.g., an MB Session Request. In an MB Session Response from MB-SMF node 18 to AMF/core network node 16, 38 or within the 5MBS session context provided by MB-SMF node 18 to AMF/core network node 16, 38, the MB-SMF node 18 includes the DisableIndividualDelivery parameter e.g., if it has earlier in step S120 been provided to MB-SMF node 18, to indicate to AMF/core network node 16, 38 whether “5MBS Individual Delivery” should not be used for this MB session.
Step S134: there are 3 different scenarios shown for this step, which depend on the 5MBS capability of NG-RAN node 10 and/or the DisableIndividualDelivery parameter from AF node 16:
Case A): If NG-RAN node 10 supports 5MBS (in other words, it has the 5MBS capability) and DisableIndividualDelivery is not present in AMF/core network node 16, 38 or is false (which may mean that AF node 16 has indicated a request for individual delivery and/or that 5MBS Individual Delivery has been enabled or not disabled by the AF node 26): AMF/core network node 16, 38 may respond to UE 12 in a NAS message: MB Session Join Accept, together with a NGAP message MB Session Join to NG-RAN node 10. NG-RAN node 10 may then prepare the individual delivery of the 5MBS session for the UE 12.
Case B): If NG-RAN node 10 does not support 5MBS (in other words, it does not have the 5MBS capability) and DisableIndividualDelivery is not present in AMF/core network node 16, 38 or is false: AMF/core network node 16, 38 may respond to UE 12 in a NAS message: MB Session Join Accept. AMF/core network node 16, 38 could also include a cause code to inform UE 12 “No 5MBS coverage and 5MBS Individual Delivery is used”. Later, 5GC may deliver the 5MBS content over a PDU session towards the UE 12.
Case C): If NG-RAN node 10 does not support 5MBS and the DisableIndividualDelivery is present AMF/core network node 16, 38 and set to true (which may mean that AF node 16 has indicated that it does not want or expect individual delivery and/or that 5MBS Individual Delivery has been disabled by the AF node 26), the AMF/core network node 16, 38 may reject UE's 12 join request in a NAS message: MB Session Join Reject. AMF/core network node 16, 38 may also include a cause code to inform UE 12 that “No 5MBS coverage and 5MBS Individual Delivery is disabled or not supported”. After receiving such response from AMF/core network node 16, 38, the UE 12 may contact the AF node 26 to switch to unicast and receive the content directly from AF node 26.

### Procedure of Session Start

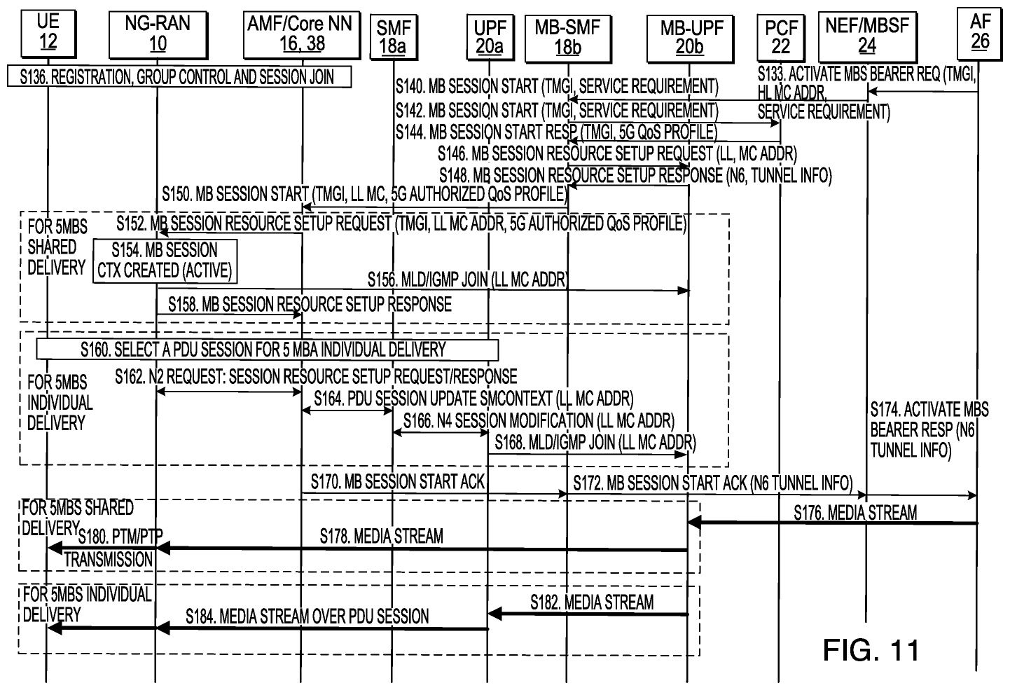

The example sequence flow in FIG. 11 illustrates enhancements to the Session Start procedure as shown in, e.g., TR 23.757 v0.4.0 clause 6.2.2.2, according to some embodiments of the present disclosure. The sequence flow may includes one or more of the following steps:
Step S136: Registration, group control and session join.
Step S138: Activate MBS bearer request.
Step S140-S144: MBS session start is requested.
Step S146-S148: MBS session resource setup is requested.
Step S150: AMF/core network node 16, 38 receives an MB Session Start request from MB-SMF 18b with a Lower layer Multicast Address (LL MC) parameter. The LL MC parameter includes the Internet Protocol (IP) multicast address and source IP address of the 5MBS session. The AMF/core network node 16, 38 may page UE(s) 12 depending on UE 12 connection management (CM)-state (see e.g., 3GPP TS 23.757 v0.4.0, clause 6.2.2.2 “Session Start”, steps 6-7).

In NG-RAN node 10 where 5MBS shared delivery is used:
Step S152: AMF/core network node 16, 38 sends an MB Session Resource Setup Request to NG-RAN node 10.
Step S154-S156: MB session created (active) and NG-RAN node 10 performs Internet Group Management Protocol/Multicast Listener Discovery (IGMP/MLD) Join towards the LL MC, i.e., the IP multicast group of the 5MBS session.
Step S158: NG-RAN node 10 responds with an MB Session Resource Setup Response to AMF/core network node 16, 38.

Then, in the user plane, after step S174, when the MB-UPF 20b receives content from AF node 26:
Steps S176-S180: 5MBS Shared Delivery is used; that is, NG-RAN node 10 receives content from the multicast group (from MB-UPF node 20b) and NG-RAN node 10 delivers the content to UE(s) 12 via Precision Time Protocol (PTP) or point-to-multipoint (PTM) transmission.

In NG-RAN node 10 (or for UEs 12) where 5MBS Individual Delivery is used (enhancements):
Step S160: AMF/core network node 16, 38 selects a PDU Session: AMF/core network node 16, 38 selects a PDU session to be used for 5MBS Individual Delivery. The PDU Session may be selected based on e.g., Data Network Name (DNN), network slice (selected/single network slice selection assistance information or SNSSAI), 5G QoS Identifier (5QI), etc. The PDU Session selection may involve interaction between AMF/core network node 16, 38 and SMF 18a. If a suitable PDU Session can not be selected or found, the AMF/core network node 16, 38 may return a MB Session Join Reject NAS message to the UE 12 with an appropriate cause code informing the UE 12 that “No 5MBS coverage and 5MBS Individual Delivery was attempted but no suitable PDU Session was found.” Alternatively, the AMF/core network node 16, 38 may trigger a Network Triggered PDU Session Establishment procedure, see 3GPP TS 23.502 clause 4.3.2.1 for example, to make the UE 12 establish a PDU Session, which the AMF/core network node 16, 38 then selects and continues to step 12.
Step S162: If radio resources for the PDU Session selected in step S160 have not already be setup, the AMF/core network node 16, 38 sends a N2 Request (Session Resource Setup Request) to NG-RAN node 10 to setup resources for the PDU Session to be used for 5MBS Individual Delivery. If the UE 12 is suspended, the NG-RAN node 10 may page the UE 12. The NG-RAN node 10 responds with a Session Resource Setup Response message to AMF/core network node 16, 38.
Step S164: AMF/core network node 16, 38 sends a PDU Session Update session management context message (SMContext message) with the LL MC information to the SMF 18a of the selected PDU Session.
Step S166: SMF 18a transmits the LL MC information to the UPF node 20a via N4 Session Modification message.
Step S168: the UPF node 20a performs an IGMP/MLD Join towards the IP multicast group of the 5MBS session using the LL MC information, unless the UPF node 20a has already joined this IP multicast group before (i.e., same IP multicast address).
Steps 170-S172: MB Session start is acknowledged.
Step S174: Activate MBS bearer response is then sent to AF node 26.

When the 5MBS media delivery starts in step S176, the MB-UPF 20b will deliver the 5MBS media also to the UPF 20a.
Step S182: the UPF node 20a receives content from the multicast group from MB-UPF node 20b. The content is received over a “shared” delivery same as in step S178 for media stream delivery to NG-RAN node 10. Note, if there are multiple PDU Sessions (for different UEs 12) in the same UPF node 20a receiving the same multicast group, the UPF node 20a will duplicate the packets incoming from the MB-UPF node 20b on the shared delivery to all the outgoing PDU Sessions in that UPF node 20a.
Step S184: the UPF node 20a delivers the content to the UE 12 over the PDU session via NG-RAN node 10, i.e. “5MBS Individual Delivery”.

### Procedure of Session Join After Session Start

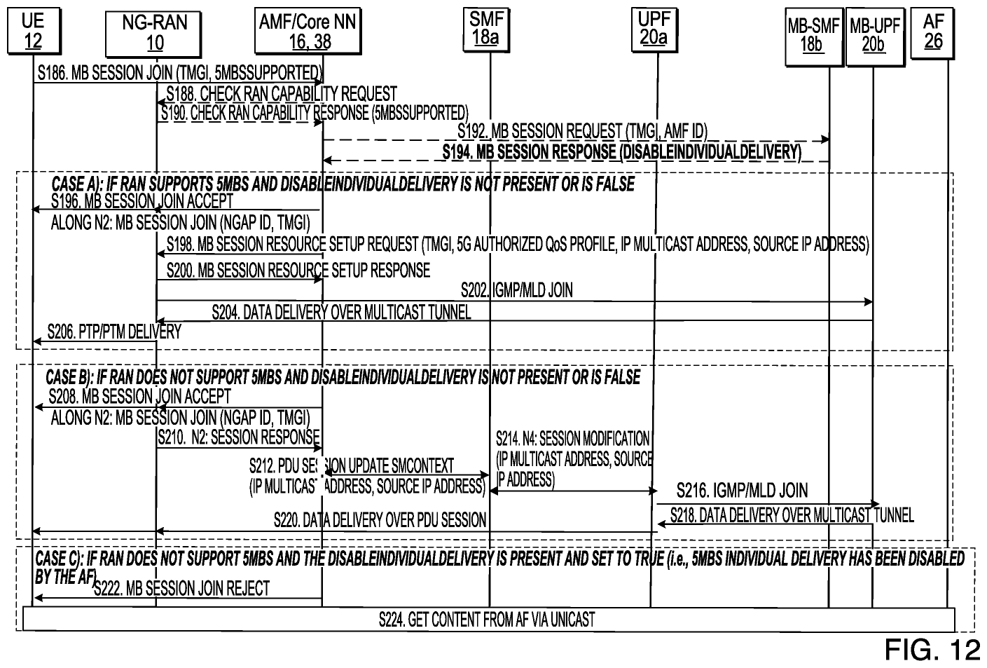

The example sequence flow in FIG. 12 illustrates the Session Join from a UE 12 after the MB session is started. It shows enhancements to the procedure in TR 23.757 v0.4.0, clause 6.2.2.4 “MCPTT: Ongoing Group Call”.

In some embodiments, the enhancements of the Session Join Procedure may allow the AMF/core network node 16, 38 to deliver 5MBS services to a UE 12 camping on a NG-RAN node 10 that does not support 5MBS. For example, in some embodiments, instead of rejecting a UE's 12 MBS Session Join Request when a RAN node 10 does not support 5MBS, the AMF/core network node 16, 38 can apply the “5MBS Individual Delivery” and accept the Join Request.

In some embodiments, included in the enhancements of the Session Join Procedure is also how the DisableIndividualDelivery parameter provided by the AF node 26 to the 5GC (e.g., as shown in FIG. 10) may be used to control the use of 5MBS Individual Delivery.

The sequence flow for an MB session join after session start according to some embodiments may include one or more of the following, as shown in FIG. 12:

Similar as Session Join before Session start, a 5MBS capability indicator (e.g., 5MBSSupported parameter/indicator) may be piggy backed by RAN node 10 in the NAS message “MB Session Join request” sent by UE 12 to AMF/core network node 16, 38 in step S186. Alternatively, AMF/core network node 16, 38 can check RAN's capability of 5MBS support in step S188 and S190. Alternatively, RAN node 10 can transmit the 5MBS capability indication to AMF/core network node 16, 38 in the NGAP setup, or AMF/core network node 16, 38 can have the RAN node 10 5MBS capability information pre-configured.

Similar as Session Join before session start, the AMF/core network node 16, 38 may query MB-SMF 18b via an MB Session Request, if AMF/core network node 16, 38 does not have the 5MBS session context in step S192. In step S194, MB-SMF 18b includes DisableIndividualDelivery in MB Session Response to AMF/core network node 16, 38. If step S192 and S194 are not executed (e.g., AMF/core network node 16, 38 does already have a 5MBS session context), a DisableIndividualDelivery parameter or flag may be present in the 5MBS session context in AMF/core network node 16, 38 if it was earlier provided by the AF node 26.

FIG. 12 illustrates example steps that may be performed based on 3 different scenarios, case A, case B and case C as described below:
Case A): If RAN supports 5MBS and DisableIndividualDelivery is not present in AMF or is false (e.g., RAN supports 5MBS and AF wants individual delivery):
Step S196: AMF/core network node 16, 38 may respond to UE 12 with a NAS message: MB Session Join Accept, together with a NGAP message MB Session Join to RAN node 10.
Step S198: AMF/core network node 16, 38 sends RAN node 10 MB Session Resource Setup request with the the IP multicast address and source IP address of the 5MBS session.
Step S200: RAN node 10 responds with a MB Session Resource Setup response to AMF/core network node 16, 38.
Step S202: RAN node 10 performs an IGMP/MLD Join towards the multicast group of the 5MBS session.
Step 5204: RAN node 10 receives the data over a multicast tunnel sent by MB-UPF 10b.
Step S206: RAN node 10 delivers the content to Ues 12 via PTP or PTM.
Case B): If RAN node 10 does not support 5MBS and DisableIndividualDelivery is not present in AMF or is false and 5MBS Individual Delivery is allowed by local AMF or network policy (e.g., RAN does not support 5MBS but AF wants individual delivery):
Step S208: AMF/core network node 16, 38 may respond to UE 12 with a NAS message: MB Session Join Accept, together with a NGAP message Session Request to RAN node 10. It could also include the cause code to inform UE 12 that “No 5MBS coverage and 5MBS Individual Delivery is used”.
Step S210: RAN node 10 may respond with a Session Response to AMF/core network node 16, 38.
Step S212: AMF/core network node 16, 38 selects the PDU session to be used for 5MBS data delivery and contacts the SMF node 18a. The AMF/core network node 16, 38 sends a PDU Session Update SMContext to SMF node 18a, with the IP multicast address and source IP address of the 5MBS session. The PDU Session may be selected based on e.g., DNN, 5G-QCI, etc. The PDU Session selection may involve interaction between AMF/core network node 16, 38 and SMF node 18a. If a suitable PDU Session can not be selected or found, the AMF/core network node 16, 38 may return a MB Session Join Reject NAS message to the UE 12 with an appropriate cause code informing the UE 12 that “No 5MBS coverage and 5MBS Individual Delivery was attempted but no suitable PDU Session was found”.
Step S214: SMF node 18a sends a N4 message: Session Modification to UPF node 20a with the IP multicast address and source IP address of the 5MBS session.
Step S216: UPF node 20a performs an IGMP/MLD Join towards the multicast group of the 5MBS session.
Step S218: UPF node 20a receives the data over multicast tunnel sent by MB-UPF node 20b.
Step 5220: UPF node 20a delivers the data over the PDU session towards UE 12 via RAN node 10.
Case C): If RAN node 10 does not support 5MBS and the DisableIndividualDelivery is present AMF and set to true (i.e. 5MBS Individual Delivery has been disabled by the AF) or 5MBS Individual Delivery is disallowed by local AMF or network policies (e.g., RAN does not support 5MBS and AF does not want individual delivery):

The MB Session Join may be rejected and the UE 12 then requests the content directly from the AF node 26 (by unicast), for example, as follows.
Step S222: AMF/core network node 16, 38 may reject UE's 12 join request in a NAS message: MB Session Join Reject. AMF/core network node 16, 38 could also include the cause code to inform the UE 12 that “No 5MBS coverage and 5MBS Individual Delivery is not supported”.
Step S224: After receiving such response from AMF/core network node 16, 38, UE 12 may request the content directly from AF node 26 (and receive over normal unicast instead).

Some embodiments of the present disclosure provide arrangements for 5MBS Individual Delivery support for e.g., Solution #2 and Architecture Option #2 in TR 23.757 v0.4.0.

Some embodiments of the present disclosure provide arrangements for how the network (e.g., AMF/core network node 16, 38) can provide 5MBS service by switching to 5MBS Individual Delivery when a UE 12 joins a MB Session in a RAN node 10 that does not support 5MBS.

Some embodiments of the present disclosure provide arrangements for how the AF node 26 can control the use of 5MBS Individual Delivery through the DisableIndividualDelivery parameter passed from the AF node 26 via MB-SMF node 18b node to the network (e.g., AMF/core network node 16, 38).

Some embodiments of the present disclosure provide arrangements for how the network (e.g., AMF/core network node 16, 38) can find out if a RAN node 10 is supporting 5MBS or not.

Some embodiments may include one or more of the following, which may be implemented by any of the core network nodes described herein (e.g., AMF node 16, or other core network node 38, such as SMF, etc.):
as a result of the request to join the MB session, at least one of:
selecting a protocol data unit, PDU, session for individual 5MBS traffic delivery to the UE 12 for the MB session;
when the AMF node 16 or other core network node 38 is unable to identify an existing PDU session for the UE 12, one of:
   triggering the UE 12 to establish a PDU session for the AMF node 16 or other core network node 38 to select; and
   transmitting the MB session response comprising the rejection to the request to join;
sending a session resource set-up request to the RAN node 10 along with an address associated with the MB session;
obtaining a session management context for the selected PDU session; and
determining whether to participate in providing individual 5MBS traffic delivery associated with the MB session to the UE 12, based at least in part on at least one of the RAN capability indication, the disable individual delivery parameter associated with the MB session and the policy associated with the AMF node 16 or other core network node 38.

One or more of the following abbreviations may be used herein:

| Abbreviation | Explanation |
|---|---|
| AF | Application Function |
| AMF | Access and Mobility Management Function |
| MBS | Multicast Broadcast Services (When used as a prefix, |
| | the MBS is sometimes used equivalent with MB) |
| MB | Multicast Broadcast |
| PSA | PDU Session Anchor |
| PDU | Packet Data Unit |
| SMF | Session Management Function |
| TMGI | Temporary Mobile Group Identity |
| UE | User Equipment |
| UPF | User Plane Function |

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a core network node, the method comprising:
determining a radio access network, RAN, capability indication indicating whether a RAN node that a user equipment, UE, is associated with supports a multicast broadcast service, MBS; and
as a result of a request from the UE to join a multicast/broadcast, MB, session, sending a MB session response, the MB session response including one of a rejection to the request to join and an acceptance of the request to join based on the RAN capability indication and further based on at least one of a disable individual delivery parameter related to the MBS and a policy, the disable individual delivery parameter indicating whether an application function, AF, node has one of enabled and disabled individual MBS traffic delivery for the MB session that the UE requested to join.

2. The method of claim 1, wherein the determining the RAN capability indication comprises one of:
obtaining the RAN capability indication from a second network node; and
internally deriving the RAN capability indication.

3. (canceled)

4. The method of claim 1, wherein:
the request to join the MB session includes at least one of the RAN capability indication and an identification of the requested MB session; and
the identification of the requested MB session includes a Temporary Mobile Group Identity, TMGI, allocated to the MB session.

5. The method of claim 1, wherein the RAN capability indication indicates whether a RAN node that the UE is associated with supports a multicast broadcast service, MBS.

6. The method of claim 1, wherein the RAN capability indication is determined based on the UE's (12) request to join the MB session.

7. (canceled)

8. The method of claim 1, wherein each of the requests to join and the response is in a non-access stratum, NAS, message.

9. The method of claim 1, wherein the MB session response includes a cause code indicating at least one of information about the RAN capability and information about individual multicast broadcast service, MBS, traffic delivery.

10. The method of claim 1, wherein the core network node is a Session Management Function, SMF.

11. A method implemented in an application function, AF, node, the method comprising:
determining whether to disable an individual multicast broadcast service, MBS, traffic delivery for a multicast/broadcast, MB, session to at least one user equipment, UE; and
sending to a network node a disable individual delivery parameter associated with the MB session based at least in part on the determination.

12. The method of claim 11, wherein the determining is based at least in part on a characteristic of an application associated with the MB session.

13. The method of claim 11, wherein the disable individual delivery parameter indicates whether the AF node one of enabled and disabled an individual traffic delivery for the MB session.

14. A core network node comprising processing circuitry, the processing circuitry configured to cause the core network node to:
determine a radio access network, RAN, capability indication indicating whether a RAN node that a user equipment, UE, is associated with supports a multicast broadcast service, MBS; and
as a result of a request from the UE to join a multicast/broadcast, MB, session, send a MB session response, the MB session response including one of a rejection to the request to join and an acceptance of the request to join based on the RAN capability indication and further based on at least one of a disable individual delivery parameter related to the MBS and a policy, the disable individual delivery parameter indicating whether an application function, AF, node has one of enabled and disabled individual MBS traffic delivery for the MB session that the UE requested to join.

15. An application function, AF, node, comprising processing circuitry, the processing circuitry configured to cause the AF node to:
determine whether to disable an individual multicast broadcast service, MBS, traffic delivery for a multicast/broadcast, MB, session to at least one user equipment, UE; and
sending to a network node a disable individual delivery parameter associated with the MB session based at least in part on the determination.

16.-18. (canceled)

19. The core network node of claim 14, wherein determining the RAN capability indication comprises one of:
obtaining the RAN capability indication from a second network node; and
internally deriving the RAN capability indication.

20. The core network node of claim 14, wherein:
the request to join the MB session includes at least one of the RAN capability indication and an identification of the requested MB session; and
the identification of the requested MB session includes a Temporary Mobile Group Identity, TMGI, allocated to the MB session.

21. The core network node of claim 14, wherein the RAN capability indication indicates whether a RAN node that the UE is associated with supports a multicast broadcast service, MBS.

22. The core network node of claim 14, wherein the RAN capability indication is determined based on the UE's (12) request to join the MB session.

23. The core network node of claim 14, wherein each of the requests to join and the response is in a non-access stratum, NAS, message.

24. The core network node of claim 14, wherein the MB session response includes a cause code indicating at least one of information about the RAN capability and information about individual multicast broadcast service, MBS, traffic delivery.

25. The application function node of claim 15, wherein the determining is based at least in part on a characteristic of an application associated with the MB session.
